(19) United States
(12) Patent Application Publication
(10) Pub. No.: US 2014/0378054 A1
(43) Pub. Date: Dec. 25, 2014

(54) OPPORTUNISTIC USE OF THE DSRC SPECTRUM

(71) Applicant: QUALCOMM Incorporated, San Diego, CA (US)

(72) Inventors: Ying Wang, Easton, PA (US); Jubin Jose, Bound Brook, NJ (US); Junyi Li, Chester, NJ (US); Xinzhou Wu, Monmouth Junction, NJ (US); Sundar Subramanian, Someriville, NJ (US)

(21) Appl. No.: 13/921,706

(22) Filed: Jun. 19, 2013

(51) Int. Cl. H04B 15/00; H04B 7/26

(52) U.S. Cl. CPC H04B 15/00; H04B 7/26
USPC 455/41.2

(57) ABSTRACT

Methods, systems, and devices are described for opportunistically using at least a portion of a dedicated short range communications (DSRC) spectrum. A multi-mode device is operated outside of the DSRC spectrum. An activity level is detected on at least a portion of the DSRC spectrum, and it is determined whether to use at least the portion of the DSRC spectrum based at least in part on the detected activity level.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations, each simultaneously supporting communication for multiple mobile devices. Base stations may communicate with mobile devices on downstream and upstream links. Each base station has a coverage range, which may be referred to as the coverage area of the cell. The available bandwidth for transmissions affects the data rate and throughput of the transmissions. As the bandwidth increases, the data rate may also increase.

Multi-mode devices that communicate on cellular and Wi-Fi networks may desire to use an increased amount of bandwidth for their transmissions. The bandwidth allocated to devices operating in the DSRC spectrum is typically used for DSRC-related transmissions. If a multi-mode device expands its bandwidth using the DSRC spectrum, it may cause interference to these DSRC-related transmissions. Thus, techniques to minimize interference to DSRC-related transmissions are desired when the DSRC spectrum is shared with devices performing non-DSRC transmissions.

### SUMMARY

The described features generally relate to one or more improved methods, systems, and/or apparatuses for opportunistically using at least a portion of a dedicated short range communications (DSRC) spectrum. In one configuration, a multi-mode device is operated outside of the DSRC spectrum. An activity level is detected on at least a portion of the DSRC spectrum, and it is determined whether to use at least the portion of the DSRC spectrum based at least in part on the detected activity level.

In one configuration, a method for opportunistically using at least a portion of the DSRC spectrum is described. In accordance with the method, a multi-mode device may be operated outside of the DSRC spectrum. An activity level may be detected on at least a portion of the DSRC spectrum, and it may be determined whether to use at least the portion of the DSRC spectrum based at least in part on the detected activity level.

In some embodiments, a transmission may be received from an access point. The transmission may include information indicating a capability of the access point to use the DSRC spectrum. Signaling information indicating a capability to use the DSRC spectrum may then be sent.

In some embodiments, detecting the activity level may include periodically scanning the DSRC spectrum to detect the activity level on the DSRC spectrum. In some cases, a report including results of at least one scan of at least the portion of the DSRC spectrum may be transmitted. In some cases, an instruction indicating whether use of at least the portion of the DSRC spectrum is allowed may be received. The instruction may be based at least in part on the activity level on at least the portion of the DSRC spectrum.

In some embodiments, a first communication channel may be established outside of the DSRC spectrum, and upon determining to use at least the portion of the DSRC spectrum, a second communication channel may be established for a transmission. At least a portion of the second communication channel may be within the DSRC spectrum. In some cases, the first communication channel may be maintained while the transmission occurs using the second communication channel. In some cases, it may be determined that the transmission in the DSRC spectrum has terminated, and the use of the second communication channel may be terminated.

In some embodiments, detecting the activity level may include detecting an energy level in the DSRC spectrum.

In some embodiments, detecting the activity level may include detecting a transmission of a packet in the DSRC spectrum, and determining whether the packet is a DSRC packet. The packet may in some cases be determined to be a DSRC packet by analyzing a preamble of the packet and determining that the packet is a DSRC packet based at least in part on one or more characteristics of the analyzed preamble.

In some embodiments, determining whether to use the DSRC spectrum may include determining whether a level of interference caused by transmissions of the multi-mode device using the DSRC spectrum is below a threshold interference level. In these embodiments, the method may further include determining whether the level of interference is below the threshold interference level for one or more different transmission power levels, or determining whether the level of interference is below the threshold interference level for one or more different antenna configurations of the multi-mode device. The threshold interference level may be based at least in part on a geographical location of the multi-mode device.

In another configuration, a device for opportunistically using at least a portion of the DSRC spectrum is described. The device may include a processor, memory in electronic communication with the processor, and instructions stored in the memory. The instructions may be executable by the processor to operate a multi-mode device outside of the DSRC spectrum; detect an activity level on at least the portion of the DSRC spectrum; and determine whether to use at least the portion of the DSRC spectrum based at least in part on the detected activity level.

In another configuration, an apparatus for opportunistically using at least a portion of the DSRC spectrum is described. The apparatus may include a means for operating a multi-mode device outside of the DSRC spectrum; a means for detecting an activity level on at least the portion of the DSRC spectrum; and a means for determining whether to use at least the portion of the DSRC spectrum based at least in part on the detected activity level.

In yet another configuration, a computer program product for opportunistically using at least a portion of the DSRC spectrum is described. The computer program product may include a non-transitory computer-readable medium storing instructions executable by a processor. the instructions may be executable by the processor to operate a multi-mode device outside of the DSRC spectrum; detect an activity level on at least the portion of the DSRC spectrum; and determine whether to use at least the portion of the DSRC spectrum based at least in part on the detected activity level.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system;

FIG. 2 is a diagram illustrating frequency band allocations along a frequency spectrum;

FIG. 3 shows a block diagram illustrating one example of a multi-mode device in accordance with various embodiments;

FIG. 4 shows a block diagram illustrating another example of a multi-mode device in accordance with various embodiments;

FIG. 5 is a block diagram illustrating yet another example of a multi-mode device in accordance with various embodiments;

FIG. 6 is a message flow diagram illustrating one example of communications between a multi-mode device and an access point to manage use of the DSRC spectrum;

FIG. 7 is a diagram illustrating allocations bandwidth for various frequency bands along a frequency spectrum that may be used for communications;

FIG. 8 is a flow chart illustrating one embodiment of a method for opportunistically using at least a portion of the DSRC spectrum; and

FIG. 9 is a flow chart illustrating a further embodiment of a method for opportunistically using at least a portion of the DSRC spectrum.

### DETAILED DESCRIPTION

Information and data may be transferred more quickly and efficiently based on the amount of available bandwidth. The size of the bandwidth (e.g., the width) may be the difference between the highest frequency and the lowest frequency in a continuous range of frequencies (typically measured in Hertz, for example). Often, the data rate limit (e.g., channel capacity, amount of information that can be transferred) is proportional to the size of the bandwidth. For example, 80 MHz of bandwidth will have a higher data rate limit than 40 MHz of bandwidth. As a result, in order to support higher data rates, more bandwidth may be required. Bandwidth occupies at least a portion of a spectrum (e.g., radio spectrum). As a result, an increase in bandwidth requires an increase in spectrum. However, additional spectrum may be difficult to obtain.

In most cases, spectrum use is regulated (e.g., allocated). For example, in the United States, spectrum use is regulated by the Federal Communications Commission (FCC). In the United States, the FCC has allocated the 5.15-5.25 GHz (e.g., U-NII 1), 5.25-5.35 GHz (e.g., U-NII 2), 5.47-5.725 GHz (e.g., U-NII WW), and 5.725-5.825 GHz (e.g., U-NII 3) frequency bands as Unlicensed National Infrastructure (U-NII) spectrum and the 5.85-5.925 GHz frequency band as dedicated short range communication (DSRC) spectrum. Thus, bandwidth for particular uses may be constrained to the space allotted in the allocated spectrum. As a result, it may not be possible to increase the available bandwidth (or the data rate limit, for example) due to the finite constraints of the allocated spectrum. Notably, however, the FCC recently issued a Notice of Proposed Rulemaking (NPRM) in which it sought comment on making the DSRC spectrum available for U-NII use, which would enable U-NII users to share the DSRC spectrum with DSRC users and increase the bandwidth available to U-NII users.

In one example, the systems and methods described herein may enable multi-mode devices that operate in the U-NII spectrum band to opportunistically use the DSRC spectrum band to increase bandwidth. For instance, the systems and methods described herein may enable U-NII users (e.g., unlicensed Wi-Fi users) to detect the existence of DSRC devices in the DSRC spectrum and share the neighboring DSRC spectrum in an undisruptive manner as secondary users. In some configurations, the multi-mode devices may take measures to reduce or eliminate interference to DSRC devices.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

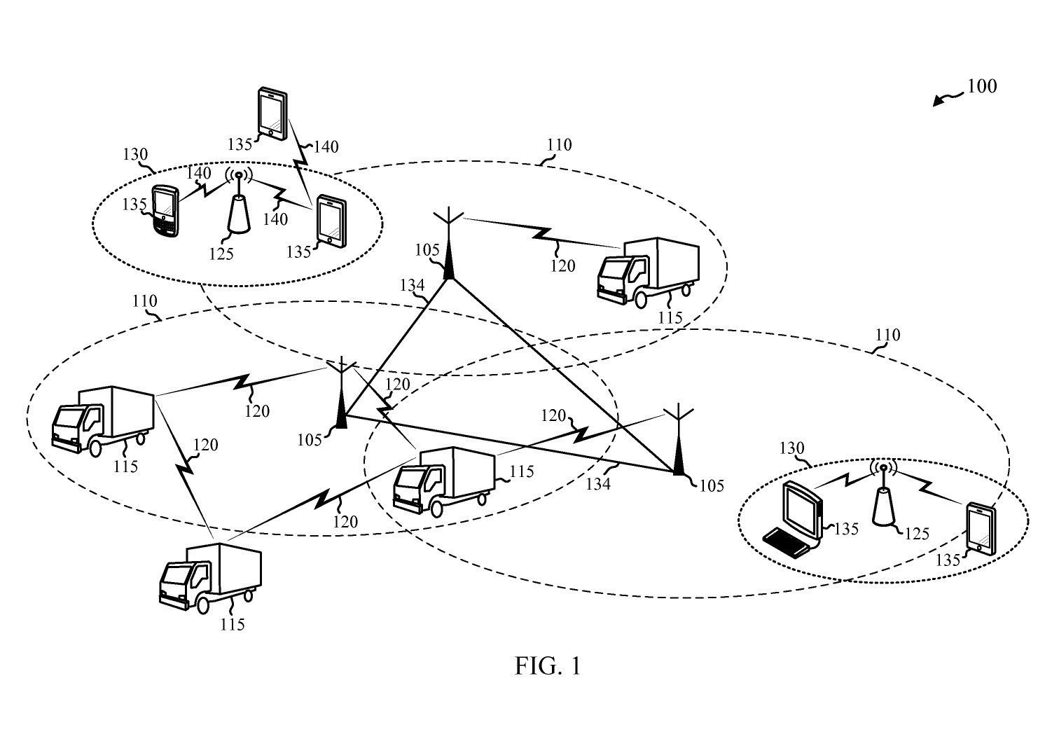

Referring first to FIG. 1, a diagram illustrates an example of a wireless communications system 100. The system 100 includes DSRC base stations (or roadside units (RSUs)) 105 and DSRC devices 115 operating within the DSRC spectrum (in a DSRC communications system, for example). The system 100 also includes communications base stations 125 and communications devices 135 operating outside of the DSRC spectrum. In one example, the communications base stations 125 and the communications devices 135 may operate in the U-NII spectrum (in a Wi-Fi communication system, for example).

The FCC initially allocated the DSRC spectrum for automotive use (e.g., intelligent transportation systems). Examples of DSRC communications include emergency warnings for vehicles, cooperative adaptive cruise control, cooperative collision warning, intersection collision avoidance, electronic parking payments, in vehicle signaling, electronic toll collection, etc. DSRC communication links 120 may be between a DSRC device 115 and a DSRC base station 105 or between a DSRC device 115 and another DSRC device 115. In some cases, DSRC communication links 120 between DSRC devices 115 may occur outside of the coverage area 110 of the DSRC base station 105. In some embodiments, the DSRC base stations 105 may communicate, either directly or indirectly, with each other over backhaul links 134, which may be wired or wireless communication links.

The DSRC devices 115 are dispersed throughout the wireless communications system 100, and each DSRC device 115 may be stationary or mobile. A DSRC device 115 may be a vehicle, traffic signal, railroad crossing, base station, cellular phone, a personal digital assistant (PDA), or the like. A DSRC device 115 may be able to communicate with the DSRC base station 105 and other DSRC devices 115. Each DSRC base station 105 may provide communication coverage for a respective DSRC geographical coverage area 110.

Multi-mode devices (also referred to as communication devices) 135 may also be dispersed through the wireless communication system 100. Each device 135 may stationary or mobile. A device 135 may also be referred to by those skilled in the art as a Wi-Fi device, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A multi-mode device 135 may be a Wi-Fi device attempting to operate within the DSRC. The device 135 may also be a cellular phone, a personal digital assistant (PDA), a wireless modem, a wireless communication device, a handheld device, a tablet computer, a laptop computer, a cordless phone, a wireless local loop (WLL) station, or the like.

A communications device 135 may be able to communicate with communications base stations 125 and/or other communications devices 135. Each of the communications base station 125 sites may provide communication coverage for a respective communications geographic coverage area 130. Communication links 140 may provide communications between a communications device 135 and a communications base station 125 and/or a communications device 135. In some embodiments, communications base stations 125 may be referred to as a base transceiver station, a radio base station, an access point, a radio transceiver, a basic service set (BSS), an extended service set (ESS), a NodeB, eNodeB (eNB), Home NodeB, a Home eNodeB, or some other suitable terminology. The coverage area 130 for a communications base station 125 may be divided into sectors making up only a portion of the coverage area (not shown).

The wireless communications system 100 may also support operation on multiple carriers (waveform signals of different frequencies). Multi-carrier transmitters can transmit modulated signals simultaneously on the multiple carriers. For example, each communication link 140 (and DSRC communication link 120, for example) may be a multi-carrier signal modulated according to the various radio technologies. Each modulated signal may be sent on a different carrier and may carry control information (e.g., reference signals, control channels, etc.), overhead information, data, etc.

As is shown in FIG. 1, the coverage area 130 of communications base stations 125 may overlap with the coverage areas 110 of the DSRC base stations 105. In the typical scenario, the overlapping coverage areas (or overlapping use outside of one or more coverage areas, for example) may not result in interference because the DSRC communication system is operating in the DSRC spectrum while the other communications system is operating outside of the DSRC spectrum (in the U-NII spectrum, for example). However, in some embodiments, the systems and methods described herein describe techniques for opportunistic use of the DSRC spectrum by the communications base station 125 and/or the communications devices 135, which could result in interference for the DSRC communication system. In one example, a multi-mode communications device 135 (or simply multi-mode device) may detect an activity level on at least a portion of the DSRC spectrum and may opportunistically use the DSRC spectrum based at least in part on the detected activity level. Additionally or alternatively, the multimode communications device 135 may opportunistically use at least a portion of the DSRC spectrum based on the location of the multimode communications device 135 being outside of a geographical area attributed to DSRC transmissions. Additionally or alternatively, the multimode communications device 135 may adapt an access parameter to yield priority to the transmissions of DSRC base stations 105 or DSRC devices operating within the DSRC spectrum. Additionally or alternatively, the multi-mode communications device 135 may use a first clock rate while operating outside of the DSRC spectrum and may switch to a second clock rate to detect transmissions using the DSRC spectrum.

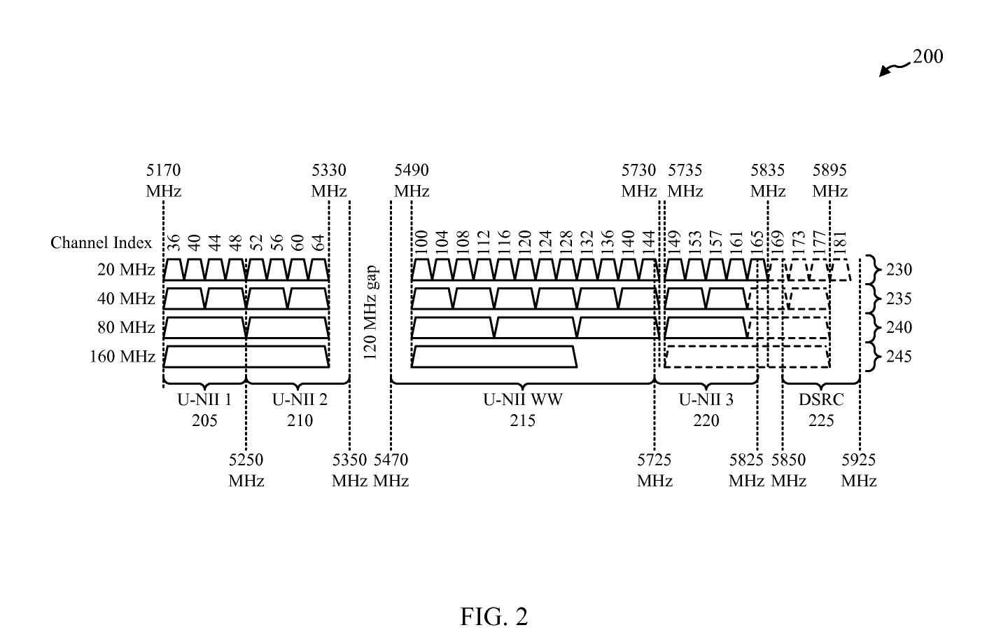

FIG. 2 shows an exemplary view of the various spectrum allocations in the 5 GHz spectrum 200. As illustrated in FIG. 2, the 5 GHz spectrum 200 includes the U-NII 1 frequency band 205 (e.g., 5170-5250 MHz), the U-NII 2 frequency band 210 (e.g., 5250-5350 MHz), the U-NII WW frequency band 215 (e.g., 5470-5725 MHz), the U-NII 3 frequency band 220 (e.g., 5725-5825 MHz), and the DSRC frequency band 225 (e.g., 5850-5925 MHz).

Each frequency band may be allocated to use one or more channels. Each channel may occupy bandwidth (e.g., 10 MHz, 20 MHz, 40 MHz, 80 MHz, 160 MHz, etc.). As noted above, increased bandwidth may result in higher data rates. As a result, increasing the number of channels and/or increasing the bandwidth of the channels may be desirable. Unfortunately, spectrum allocations may limit the number and/or the size of channels. For example, the U-NII 1 frequency band 205 (which occupies 80 MHz, for example) may support up to four 20 MHz channels 230 (with channel indexes 36, 40, 44, and 48, for example), up to two 40 MHz channels 235, or one 80 MHz channel 240. Similarly, the U-NII 2 frequency band 210 may support up to four 20 MHz channels 230 (with channel indexes 52, 56, 60, and 64, for example), up to two 40 MHz channels 235, or one 80 MHz channel 240. As a result, neither the U-NII 1 frequency band 205 nor the U-NII 2 frequency band 210 by may individually support a 160 MHz channel 245. Certain devices (e.g., Wi-Fi device) may operate across both the U-NII 1 and U-NII 2 frequency bands 205, 210. As a result the U-NII 1 and U-NII 2 frequency bands 205, 210 may effectively be combined to result in a 5170-5350 MHz frequency band. Accordingly, a 160 MHz channel 245 (e.g., 5170-5330 MHz) may be supported.

As illustrated in FIG. 2, the U-NII 3 frequency band 220 (e.g., 5725-5825 MHz) may support up to five 20 MHz channels 230 (with channel indexes 149, 153, 157, 161, and 165, for example), up to two 40 MHz channels 235, or one 80 MHz channel 240. Typically, the DSRC frequency band 225 supports DSRC communications using 10 MHz channels. In some cases, the systems and methods described herein may opportunistically use the DSRC frequency band (as secondary users, for example). In one embodiment, multi-mode devices may use the DSRC spectrum when they are located in an area that is not attributed to DSRC transmissions. As a result, the U-NII 3 and DSRC frequency bands 220, 225 may effectively be combined to result in a 5725-5925 MHz frequency band. Accordingly, the combined frequency bands may support up to nine 20 MHz channels 230 (with channel indexes 149, 153, 157, 161, 165, 169, 173, 177, and 181, for example), up to four 40 MHz channels 235, up to two 80 MHz channels 240, and up to one 160 MHz channel 245. Thus, sharing of the DSRC spectrum may substantially increase the number of the available channels and/or the size of the available channels. In one example, spectrum sharing across the U-NII and DSRC frequency bands may support up to twenty nine 20 MHz channels 230, up to fourteen 40 MHz channels 235, up to seven 80 MHz channel 240, and up to three 160 MHz channels 245. These increases may enable increased data rates (allowing for higher throughput, for example). For instance, the increased data rates may be used to transmit high definition video formats (Ultra High Definition Television (UHDTV), for example).

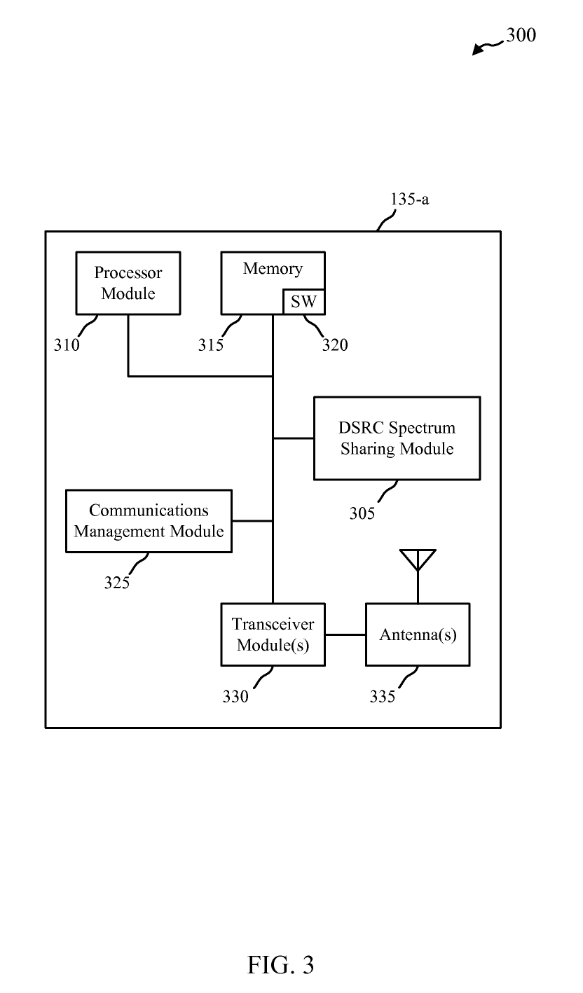

FIG. 3 is a block diagram 300 of a device 135-a. The device 135-a may be an example of one or more aspects of the multi-mode devices 135 described with reference to FIG. 1. The device 135-a may have any of various configurations, such as that of a Wi-Fi device, a personal computer (e.g., a laptop computer, a netbook computer, a tablet computer, etc.), a cellular telephone, a personal digital assistant (PDA), a digital video recorders (DVR), an internet appliance, a gaming console, an e-reader, etc. The device 135-a may have an internal power supply (not shown), such as a small battery, to facilitate mobile operation.

The device 135-a may include at least one antenna (antenna(s) 335), at least one transceiver module (transceiver module(s) 330), memory 315, and a processor module 310, which each may be in communication, directly or indirectly, with each other (e.g., via one or more buses). The transceiver module(s) 330 may be configured to communicate bi-directionally, via the antenna(s) 335 and/or one or more wired or wireless links, with one or more networks, as described with reference to FIG. 1. For example, the transceiver module(s) 330 may be configured to communicate bi-directionally with one or more of the access points 125 or other multi-mode devices 135 of FIG. 1. The transceiver module(s) 330 may include at least one modem configured to modulate packets and provide modulated packets to the antenna(s) 335 for transmission, and to demodulate packets received from the antenna(s) 335. While the device 135-a may include a single antenna, the device 135-a will typically include multiple antennas for multiple links.

The memory 315 may include random access memory (RAM) and/or read-only memory (ROM). The memory 315 may store computer-readable, computer-executable software code 320 containing instructions that are configured to, when executed, cause the processor module 310 to perform various functions described herein (e.g., DSRC spectrum sharing, etc.). Alternatively, the software code 320 may not be directly executable by the processor module 310 but be configured to cause the device 135-a (e.g., when compiled and executed) to perform functions described herein.

The processor module 310 may include an intelligent hardware device, e.g., a central processing unit (CPU), a microcontroller, an application specific integrated circuit (ASIC), etc. The processor module 310 may include a speech encoder (not shown) configured to receive audio via a microphone, convert the audio into packets (e.g., 30 ms in length) representative of the received audio, provide the audio packets to the transceiver module(s) 330, and provide indications of whether a user is speaking. Alternatively, an encoder may only provide packets to the transceiver module(s) 330, with the provision or withholding/suppression of the packet itself providing the indication of whether a user is speaking.

According to the architecture of FIG. 3, the device 135-a may further include a communications management module 325. The communications management module 325 may manage communications with other devices 135. By way of example, the communications management module 325 may be a component of the multi-mode device 135-a in communication with some or all of the other components of the multi-mode device 135-a via a bus. Alternatively, functionality of the communications management module 325 may be implemented as a component of one or more of the transceiver module(s) 330, as a computer program product, and/or as one or more controller elements of the processor module 310.

The device 135-a may further include a DSRC spectrum sharing module 305. The spectrum sharing module 305 may manage the device's opportunistic use of the DSRC spectrum. The module 305 may make a determination to operate within the DSRC spectrum based on a number of factors. For example, the module 305 may allow operation within the DSRC spectrum based on a detected activity level on at least a portion of the DSRC spectrum (e.g., a detected activity level of other devices using at least the portion of the DSRC spectrum). By way of further example, the module 305 may determine whether a level of interference caused by transmissions of the multi-mode device 135-a using the DSRC spectrum is below a threshold interference level, and only allow DSRC spectrum use when the level of interference is below the threshold interference level.

The DSRC spectrum sharing module 305 may modify one or more parameters or operations of the device 135-a to detect the activity of devices operating in the DSRC spectrum. While operating in the DSRC spectrum, the module 305 may alter one or more communication parameters of the device 135-a. These parameters may be altered, in some cases, to provide priority to communications originating from devices that are attributed to DSRC transmissions. The altered parameters may include, for example, a transmission power level or antenna configuration of the device 135-a.

The components of the device 135-a may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the device 135-a.

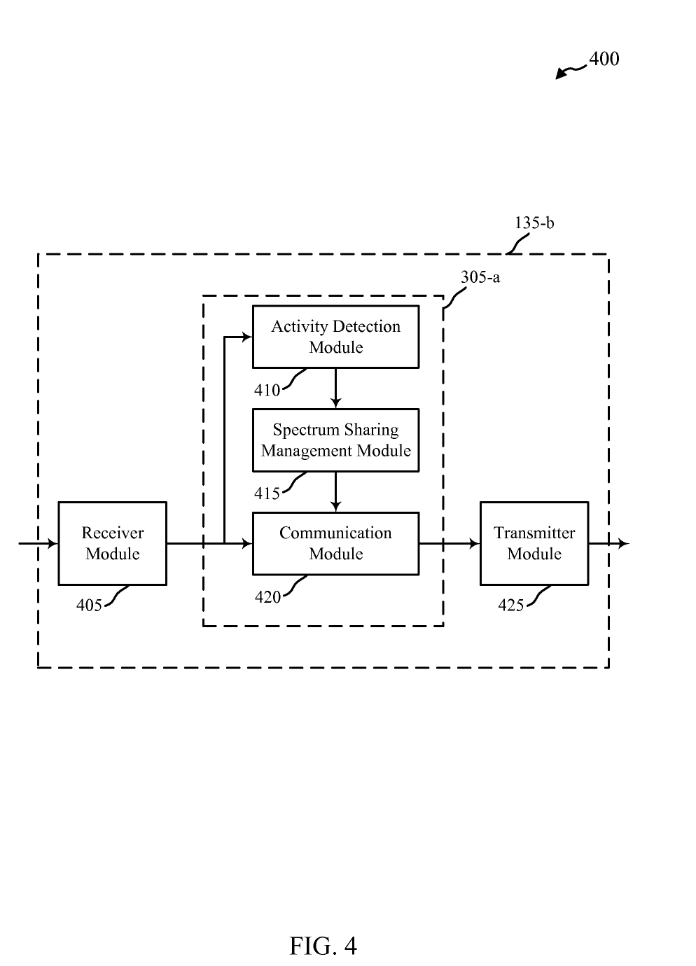

FIG. 4 is a block diagram 400 illustrating an example of a device 135-b that may opportunistically use at least a portion of the DSRC spectrum. The device 135-b may be an example of one or more aspects of the multi-mode devices 135 described with reference to FIGS. 1 and/or 3. The device 135-b may include a receiver module 405, a DSRC spectrum sharing module 305-a, and/or a transmitter module 425. Each of these components may be in communication with each other.

The components of the device 135-b may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 405 may include a Wi-Fi receiver and may receive various Wi-Fi signals. The receiver module 405 may also include a cellular receiver, and in some cases may include an LTE/LTE-A receiver. The receiver module 405 may be used to receive various types of data and/or control signals over a wireless communications system, such as the wireless communications system 100 described with reference to FIG. 1. The receiver module 405 may be further configured to receive data and/or control signals using at least a portion of the DSRC spectrum.

The transmitter module 425 may also include a Wi-Fi transmitter. The Wi-Fi transmitter may be capable of transmitting signals over a Wi-Fi connection. The transmitter module 425 may also include a cellular transmitter, and in some cases may include an LTE/LTE-A transmitter. The transmitter module 425 may be used to transmit various types of data and/or control signals over a wireless communications system such as the wireless communications system 100. The transmitter module 425 may be further configured to transmit data and/or control signals using at least a portion of the DSRC spectrum.

The DSRC spectrum sharing module 305-a may be an example of one or more aspects of the DSRC spectrum sharing module 305 described with reference to FIG. 3. In some embodiments, the module 305 may include an activity detection module 410, a spectrum sharing management module 415, and/or a communication module 420. The activity detection module 410 may by used by the device 135-b to detect an activity level on at least a portion of the DSRC spectrum. The DSRC spectrum sharing management module 415 may then determine whether to use at least the portion of the DSRC spectrum based at least in part on the detected activity level determined by the activity detection module 410. In one embodiment, if the detected activity level on at least the portion of the DSRC spectrum is high, or if the device 135-b determines that a level of interference caused by transmissions of the device 135-b using the DSRC spectrum is above a threshold interference level (e.g., the device 135-b may interfere with the transmission of DSRC devices), the DSRC spectrum sharing management module 415 may determine not to use the DSRC spectrum and the device 135-b may continue to operate outside of the DSRC spectrum. Otherwise, the device 135-b may proceed to use the DSRC spectrum, and in some cases may use both the DSRC spectrum and a non-DSRC spectrum cooperatively.

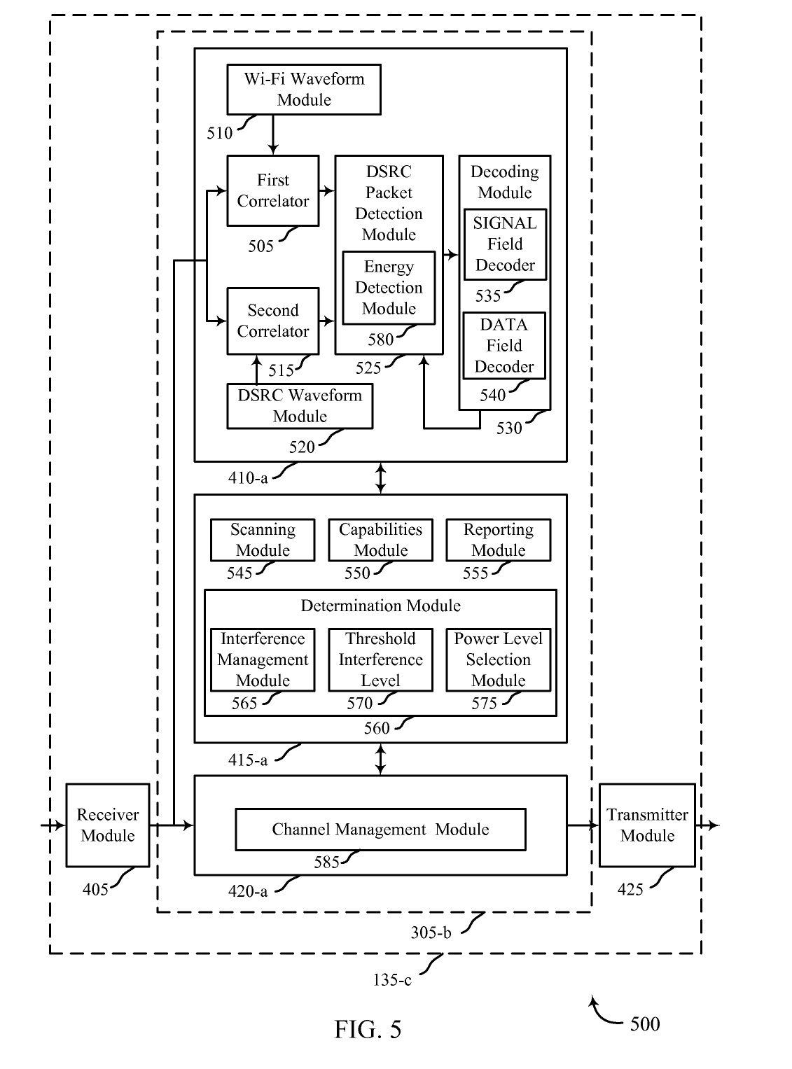

FIG. 5 is a block diagram 500 illustrating an example of a device 135-c that may opportunistically use at least a portion of the DSRC spectrum. The device 135-c may be an example of one or more aspects of the multi-mode devices 135 described with reference to FIGS. 1, 3, and/or 4. The device 135-c may include a receiver module 405, a DSRC spectrum sharing module 305-b, and/or a transmitter module 425. Each of these components may be in communication with each other.

The components of the device 135-c may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

In one embodiment, the receiver module 405 and the transmitter module 425 may be configured to operate as previously described with reference to FIG. 3. The DSRC spectrum sharing module 305-b may include an activity detection module 410-a, a spectrum sharing management module 415-a, and/or a communication module 420-a. Each of these components may be an example of one or more aspects of the respective activity detection module 410, spectrum sharing management module 415, and communication module 420 described with reference to FIG. 4.

The spectrum sharing management module 415-a may include a scanning module 545 that causes the device 135-c to periodically scan the DSRC spectrum to detect the activity level on at least a portion of the DSRC spectrum. As a result of the scanning, the receiver module 405 may receive a variety of signals, including signals that are not intended for the device 135-c. The activity detection module 410-a may process these signals to detect the activity level on at least the portion of the DSRC spectrum. In some cases, the DSRC spectrum is only scanned when the device 135-c is in need of more or wider bandwidth (e.g., for high definition video streaming) When the device 135-c is not in need of more or wider bandwidth, power may be saved by not scanning the DSRC spectrum.

The activity detection module 410-a may in some cases include a first correlator 505 and a second correlator 515. Each of the correlators 505, 515 may receive incoming signals via the receiver module 405. The first correlator 505 may attempt to correlate the incoming signals with a Wi-Fi waveform provided by a Wi-Fi waveform module 510, to determine whether the incoming signals include Wi-Fi signals. The second correlator 515 may attempt to correlate the incoming signals with a DSRC waveform (e.g., a DSRC packet preamble waveform) provided by a DSRC waveform module 520, to determine whether the incoming signals include DSRC signals. The DSRC signals may also be distinguished from the Wi-Fi signals because of differences in the bandwidths of their transmissions. When the incoming signals are determined to include DSRC signals, a DSRC packet detection module 525 may detect a transmission of one or more packets in the DSRC spectrum and determine whether each of the one or more packets is a DSRC packet. To determine whether a packet is a DSRC packet, the DSRC packet detection module 525 may in some cases analyze a DSRC packet preamble identified by the second correlator 515. The DSRC packet detection module 525 may also rely on information received from the decoding module 530. The decoding module 530 may include a SIGNAL field decoder 535 and a DATA field decoder 540. The SIGNAL field decoder 535 may decode the SIGNAL field of the packet to determine the packet's length, while the DATA field decoder 540 may decode the DATA field of the packet to determine more information about the packet. The information obtained by the decoding module 530 may be provided to the DSRC packet detection module 525 for purposes of confirming the existence of a DSRC packet. The DSRC packet detection module 525 may also or alternately determine whether a packet is a DSRC packet by means of energy detection, and may therefore include an energy detection module 580. The energy detection module 580 may detect an energy level in the DSRC spectrum by, for example, detecting the received energy level in each of a number of time slots and determining when energy is present in the DSRC spectrum (indicating the transmission of a packet in the DSRC spectrum) or not present in the DSRC spectrum (indicating that the DSRC spectrum is not being used). Energy detection is typically a coarser way to determine whether transmissions are being made (or packets are being transmitted) in the DSRC spectrum.

Returning now to the spectrum sharing management module 415-a, the module 415-a may further include a reporting module 555. The reporting module 555 may receive from the activity detection module 410-a a report including results of at least one scan of the at least portion of the DSRC spectrum, and may cause the report to be transmitted to an access point or other multi-mode device (e.g., one of the access points 125 or multi-mode devices 135 described with reference to FIG. 1).

The spectrum sharing management module 415-a may further include a capabilities module 550. The capabilities module 550 may be configured to receive, from an access point 125 or other multi-mode device 135, a transmission including information indicating a capability of the access point or other multi-mode device to use the DSRC spectrum. The capabilities module 550 may also be configured to send signaling information (e.g., to the access point 125 or other multi-mode device 135) indicating a capability of the device 135-c to use the DSRC spectrum.

The spectrum sharing management module 415-a may also include a determination module 560. The determination module 560 may determine whether to use at least the portion of the DSRC spectrum. The determination may be based at least in part on the detected activity level on at least the portion of the DSRC spectrum. The determination may also be based on receipt of an instruction (e.g., from an access point 125 or other multi-mode device 135) indicating that use of at least the portion of the DSRC spectrum is allowed. If the detected activity level on at least the portion of the DSRC spectrum is too high, use of the DSRC spectrum may not be allowed.

When use of the DSRC spectrum is allowed, it may be desirable to regulate or discontinue the use so as not to interfere with the transmission of DSRC devices. In this regard, the determination module 560 may include an interference management module 565, a threshold interference level 570, and/or a power level selection module 575. The interference management module 565 may determine whether a level of interference caused by transmissions of the multi-mode device 135-c using the DSRC spectrum is below a threshold interference level. If so, the device 135-c may be allowed to continue transmissions in the DSRC spectrum. If not, the device's transmissions may be regulated or terminated. For example, in one embodiment, it may be determined whether the level of interference is below a threshold interference level for one or more different transmission power levels, and if so, an appropriate one of the transmission power levels may be selected for DSRC transmissions using the power level selection module 575. In another embodiment, it may be determined whether the level of interference is below a threshold interference level for one or more different antenna configurations of the device 135-c, and if so, an appropriate one of the antenna configurations may be selected for DSRC transmissions. The threshold interference level 570 may be static or dynamic. For example, in some cases, the threshold interference level may be based at least in part on a geographical location of the device 135-c. The threshold interference level may be set higher for geographic locations where more DSRC activity is expected (e.g., in cities or near major roads), and lower for geographic locations where less DSRC activity is expected.

Turning now to the communication module 420-a, the module 420-a may include a channel management module 585. The channel management module 585 may establish one or more communication channels to operate the device 135-c outside and/or within the DSRC spectrum. For example, the channel management module 585 may initially establish a first communication channel for operating the device 135-c outside the DSRC spectrum. Then, upon the determination module 560 determining that use of at least a portion of the DSRC spectrum is allowed, the channel management module 585 may establish a second communication channel, with at least a portion of the second communication channel being within the DSRC spectrum. The channel management module 585 may maintain the first communication channel after establishing the second communication channel. This may enable the device 135-c to more easily terminate use of the second communication channel should its DSRC use interfere with the DSRC use of DSRC devices.

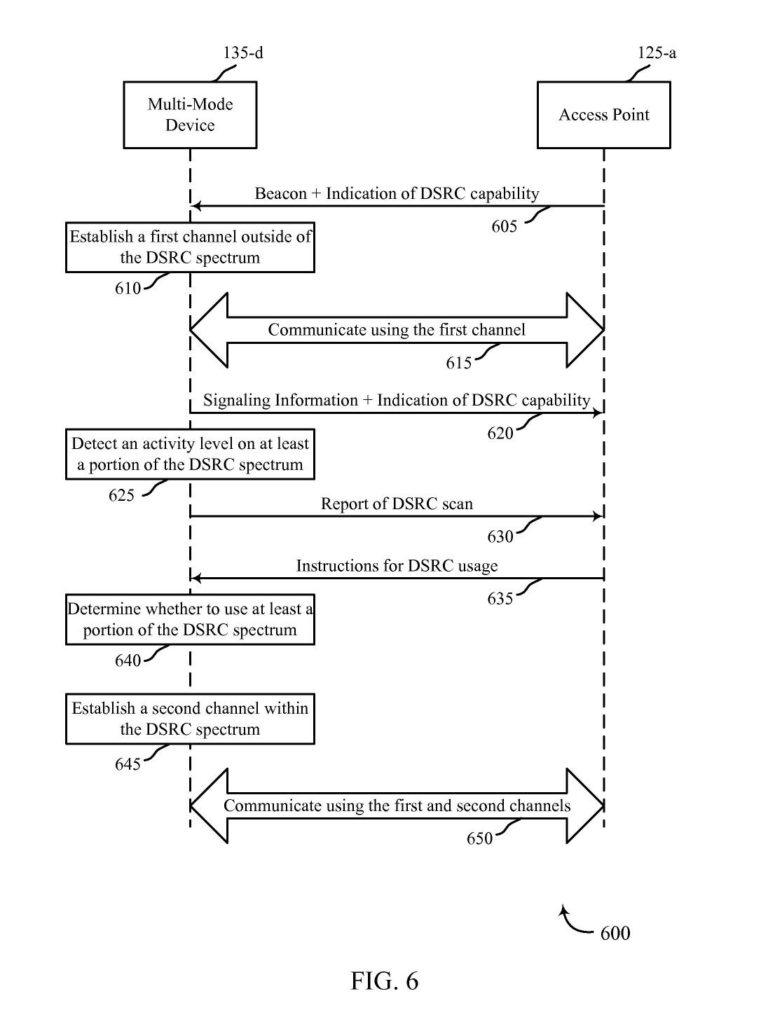

FIG. 6 is a message flow diagram 600 illustrating one example of communications between a multi-mode device 135-d and an access point 125-a. The multi-mode device 135-d may be an example of aspects of one or more of the multi-mode devices 135 described with reference to FIGS. 1, 3, 4, and/or 5. The access point 125-a may be an example of aspects of one or more of the access points 125 described with reference to FIG. 1. In some embodiments, the functions of the access point 125-a may be performed by another multi-mode device 135.

The message flow may begin with the multi-mode device 135-d receiving, from the access point 125-a, a transmission 605 including information indicating a capability of the access point 125-a to use the DSRC spectrum. In alternate embodiments, the transmission 605 may occur later in the message flow.

At some point in time, the multi-mode device 135-d may establish 610 a first communication channel outside of the DSRC spectrum, and may proceed to communicate with the access point 125-a using the first communication channel 615. In addition to communications for which the multi-mode device 135-d is intended, the multi-mode device 135-d may send signaling information 630 indicating its capability to use the DSRC spectrum to the access point 125-a.

At some point in time, the multi-mode device 135-d may detect 625 an activity level on at least a portion of the DSRC spectrum. The activity level may be detected, in some cases, by periodically scanning the DSRC spectrum to detect the activity level. The detected activity level may be reported 630 to the access point 125-a using the first communication channel. In some cases, this may involve transmitting a report including results of at least one of the scans of the DSRC spectrum.

The access point 125-b may analyze the detected activity level reported by the multi-mode device 135-d and use the detected activity level in determining what instructions to give the multi-mode device 135-d regarding use of at least the portion of the DSRC spectrum. When use of at least the portion of the DSRC spectrum is allowed, the multi-mode device 135-d may receive instructions 635 to this effect. The instructions 635 may be received at the multi-mode device 135-d over the first communication channel.

The multi-mode device 135-d may use the instructions 635 for DSRC usage to determine 640 whether it is allowed to operate using at least a portion of the DSRC spectrum. If the instructions indicate that the multi-mode device 135-d is allowed to operate within the DSRC spectrum, the multi-mode device 135-d may establish 645 a second communication channel. The second communication channel may be established with the access point 125-a, but unlike the first communication channel, at least a portion of the second communication channel may be within the DSRC spectrum. The multi-mode device 135-d and the access point 125-a may then engage in communications 650 using the first communication channel and/or the second communication channel.

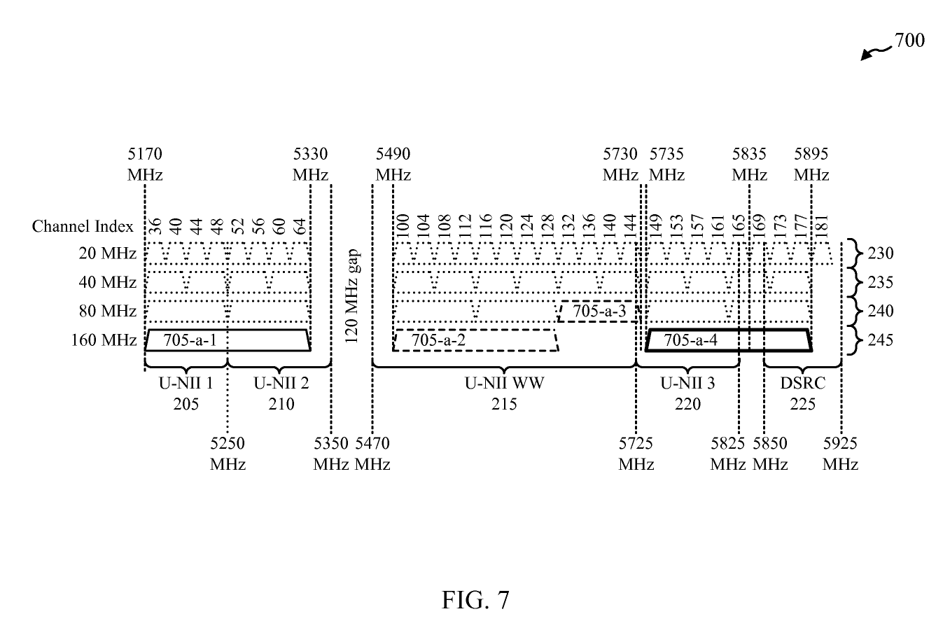

FIG. 7 shows an exemplary view of various spectrum allocations in the 5 GHz spectrum 700 and the use of the DSRC spectrum by a multi-mode device 135. As previously described, the spectrum 700 may include different allocations of frequency bands along the spectrum 700. In one configuration, each frequency band allocation may use a certain number of frequency channels. Each channel may occupy a certain amount of bandwidth. As illustrated, the U-NII 1 frequency band 205 may support up to four 20 MHz channels 230, two 40 MHz channels 235, or one 80 MHz channel 240. Similarly, the U-NII 2 frequency band 210 may support up to four 20 MHz channels 230, two 40 MHz channels 235, or one 80 MHz channel 240. As previously stated, neither the U-NII 1 frequency band 205 nor the U-NII 2 frequency band 210 may individually support a 160 MHz channel 705-a-1. However, since a multi-mode device 135 may operate across both bands 205, 210, the device may effectively use the 160 MHz channel across both frequency bands.

As further illustrated, the U-NII WW band 215 may support a 160 MHz channel 705-a-2. A 160 MHz channel 705-a-3 may also be supported across the bands for the U-NII 3 frequency band 220 and the DSRC frequency band 225. In one embodiment, when a multi-mode device 135 determines that it is located in an area where use of the DSRC spectrum is permitted, it may use at least a portion DSRC spectrum 225. As a result, the bandwidth for the transmissions of the device 135 may be increased as the device may operate on the 160 MHz channel 705-a-1 across the U-NII 1 205 and U-NII 2 210 bands, the 160 MHZ channel 705-a-2 in the U-NII WW band 215, as well as the 160 MHz channel 705-a-3 across the U-NII 3 spectrum 220 and the DSRC spectrum 225. This increase in bandwidth for the multi-mode device's 135 transmissions may enable increased data rates, which may allow for higher throughput.

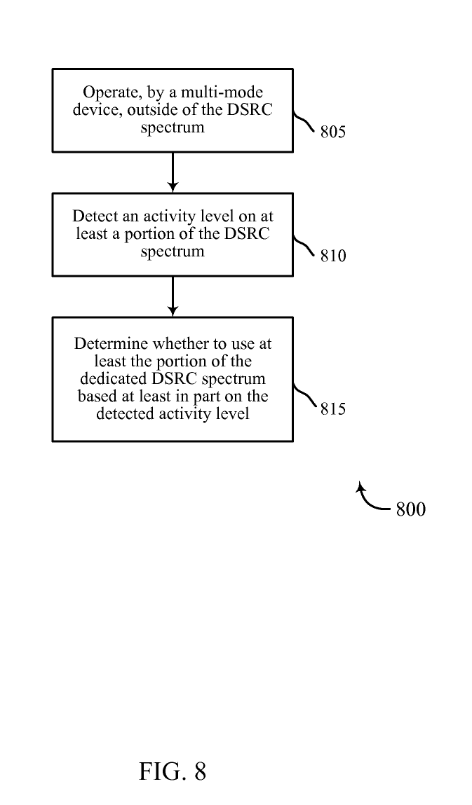

FIG. 8 is a flow chart illustrating one embodiment of a method 800 for opportunistically using at least a portion of the DSRC spectrum. For clarity, the method 800 is described below with reference to aspects of one or more of the multi-mode devices 135 described with reference to FIGS. 1, 3, 4, 5, and/or 6. In one implementation, the DSRC spectrum sharing module 305 described with reference to FIGS. 3, 4, and/or 5 may execute one or more sets of codes to control the functional elements of a multi-mode device 135 to perform the functions described below.

At block 805, a multi-mode device 135 may operate outside of the DSRC spectrum. By way of example, the multi-mode device 135 may be operated in a spectrum outside of the DSRC spectrum by operating the multi-mode device 135 in a spectrum adjacent the DSRC spectrum, such as a Wi-Fi spectrum. In some embodiments, the communication module 420 described with reference to FIGS. 4 and/or 5 may be used to operate the multi-mode device 135 outside of the DSRC spectrum.

At block 810, an activity level may be detected on at least a portion of the DSRC spectrum. In some embodiments, the activity level may be detected using the activity detection module 410 described with reference to FIGS. 4 and/or 5.

At block 815, a determination regarding whether to use at least the portion of the DSRC spectrum may be made. The determination may be based at least in part on the detected activity level. In some embodiments, the determination made at block 815 may be made using the spectrum sharing management module 415 described with reference to FIGS. 4 and/or 5 or the determination module 560 described with reference to FIG. 5.

Therefore, the method 800 may be used for opportunistically using at last a portion of the DSRC spectrum. It should be noted that the method 800 is just one implementation and that the operations of the method 800 may be rearranged or otherwise modified such that other implementations are possible.

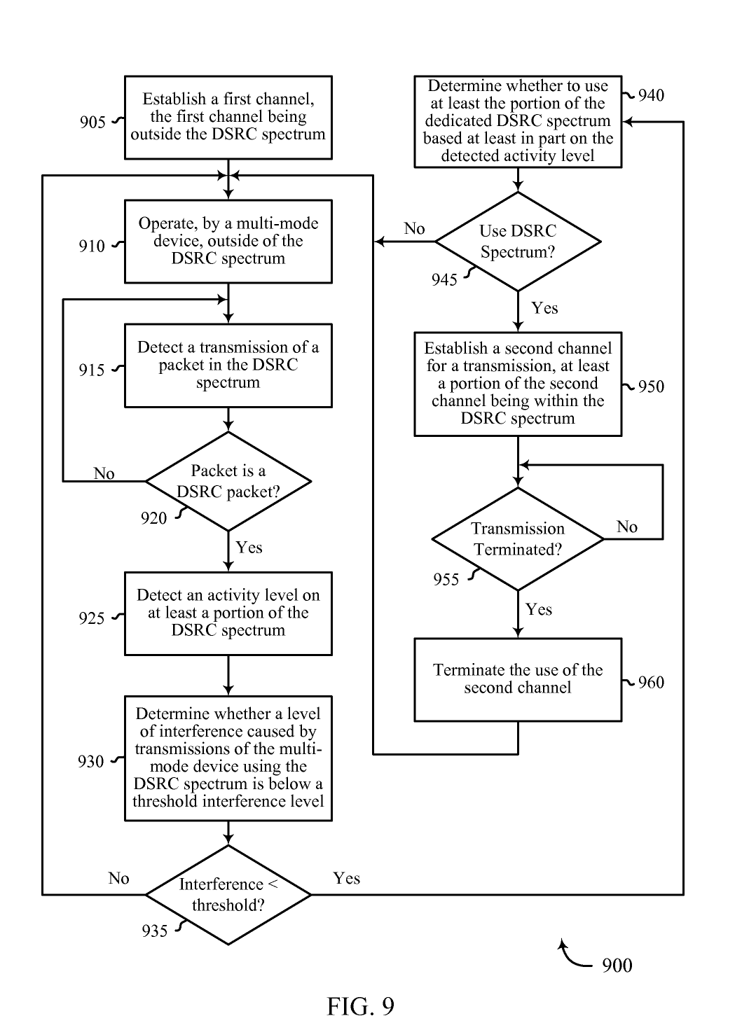

FIG. 9 is a flow chart illustrating a further embodiment of a method 900 for opportunistically using at least a portion of the DSRC spectrum. For clarity, the method 900 is described below with reference to aspects of one or more of the multi-mode devices 135 described with reference to FIGS. 1, 3, 4, 5, and/or 6. In one implementation, the DSRC spectrum sharing module 305 described with reference to FIGS. 3, 4, and/or 5 may execute one or more sets of codes to control the functional elements of a multi-mode device 135 to perform the functions described below.

At block 905, a multi-mode device 135 may establish a first communication channel. The multi-mode device 135 may then be operated outside of the DSRC spectrum at block 910. By way of example, the first communication channel may be established in a spectrum adjacent the DSRC spectrum, such as a Wi-Fi spectrum, and the multi-mode device 135 may be operated outside of the DSRC spectrum by operating the multi-mode device 135 in the spectrum adjacent the DSRC spectrum. In some embodiments, the communication module 420 described with reference to FIGS. 4 and/or 5 may be used to establish the first communication channel and/or operate the multi-mode device 135 outside of the DSRC spectrum.

At block 915, a transmission of a packet in the DSRC spectrum may be detected. It may then be determined, at block 920, whether the packet is a DSRC packet. Determining whether the packet is a DSRC packet may include, in some cases, analyzing a preamble of the packet and determining that the packet is a DSRC packet based at least in part on one or more characteristics of the analyzed preamble. When it is determined that the packet is not a DSRC packet, block 920 may operate to return flow of the method 900 to block 915. However, when it is determined that the packet is a DSRC packet, block 920 may allow the method 900 to proceed to block 925. In some embodiments, the operations at blocks 915 and 920 may be performed using the DSRC packet detection module 525 described with reference to FIG. 5.

At block 925, an activity level may be detected on at least a portion of the DSRC spectrum. In some cases, the activity level may be detected based at least in part on the detection and determination made at blocks 915 and 920. Alternately or additionally, the activity level may be detected by, for example, detecting an energy level in the DSRC spectrum. In some embodiments, the activity level may be detected using the activity detection module 410 described with reference to FIGS. 4 and/or 5.

At block 930, it may be determined whether to use the DSRC spectrum by determining whether a level of interference caused by transmissions of the multi-mode device 135 using the DSRC spectrum is below a threshold interference level. In some cases, this may include determining whether the level of interference is below the threshold interference level for one or more different transmission power levels. In other cases, this may include determining whether the level of interference is below the threshold interference level for one or more different antenna configurations of the multi-mode device 135.

The threshold interference level used at block 930 may in some cases be dynamic. For example, the threshold interference level may in some cases be based at least in part on a geographical location of the multi-mode device 135.

When the level of interference caused by transmissions of the multi-mode device 135 using the DSRC spectrum is determined to be above the threshold interference level, block 935 may operate to return flow of the method 900 to block 910. However, when the level of interference caused by the transmissions using the DSRC spectrum is determined to be below the threshold interference level, block 920 may allow the method 900 to proceed to block 940.

In some embodiments, the operations performed at blocks 930 and 935 may be performed using the determination module 560 described with reference to FIG. 5.

At block 940, a determination regarding whether to use at least the portion of the DSRC spectrum may be made. The determination may be based at least in part on the detected activity level. When it is determined not to use at least the portion of the DSRC spectrum, block 945 may operate to return flow of the method 900 to block 910. However, when it is determined to use at least the portion of the DSRC spectrum, block 945 may allow the method 900 to proceed to block 950. In some embodiments, the operations at blocks 940 and 945 may be performed using the spectrum sharing management module 415 described with reference to FIGS. 4 and/or 5 or the determination module 560 described with reference to FIG. 5.

At block 950, a second communication channel may be established for a transmission (e.g., a transmission to or from the multi-mode device 135). At least a portion of the second communication channel may be within the DSRC spectrum. In some case, the first communication channel may be maintained regardless of whether the second communication channel is established (e.g., the first communication channel may be maintained while the transmission occurs using the second communication channel). In some cases the transmission may be made using both the first and second communication channels. In some embodiments, the operations at block 950 may be performed using the communication module 420 described with reference to FIGS. 4 and/or 5 or the channel management module 585 described with reference to FIG. 5.

At block 955, it may be determined whether the transmission in the DSRC spectrum has terminated. When it is determined that the transmission has not terminated, block 955 may cause the method 900 to repeat the determination made at block 915 (e.g., to loop). The determination may be repeated, for example, periodically or upon the occurrence of one or more events. When it is determined that the transmission has terminated, block 955 may allow the method 900 to proceed to block 960.

At block 960, use of the second communication channel (i.e., the communication channel established in the DSRC spectrum) may be terminated and flow of the method 900 may return to block 910. In some cases, the first communication channel may be maintained despite the termination of the second communication channel. In some embodiments, the operations at blocks 955 and 960 may be performed using the communication module 420 described with reference to FIGS. 4 and/or 5 or the channel management module 585 described with reference to FIG. 5.

Therefore, the method 900 may be used for opportunistically using at last a portion of the DSRC spectrum. It should be noted that the method 900 is just one implementation and that the operations of the method 900 may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS. LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

The communication networks that may accommodate some of the various disclosed embodiments may be packet-based networks that operate according to a layered protocol stack. For example, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARQ) to provide retransmission at the MAC layer to improve link efficiency. At the Physical layer, the transport channels may be mapped to Physical channels.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration. A processor may in some cases be in electronic communication with a memory, where the memory stores instructions that are executable by the processor.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

A computer program product or computer-readable medium both include a computer-readable storage medium and communication medium, including any mediums that facilitates transfer of a computer program from one place to another. A storage medium may be any medium that can be accessed by a general purpose or special purpose computer. By way of example, and not limitation, computer-readable medium can comprise RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote light source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for opportunistically using at least a portion of a dedicated short range communications (DSRC) spectrum, comprising:
operating, by a multi-mode device, outside of the DSRC spectrum;
detecting an activity level on at least the portion of the DSRC spectrum; and
determining whether to use at least the portion of the DSRC spectrum based at least in part on the detected activity level.

2. The method of claim 1, further comprising:
receiving, from an access point, a transmission comprising information indicating a capability of the access point to use the DSRC spectrum; and
sending signaling information indicating a capability to use the DSRC spectrum.

3. The method of claim 1, wherein the detecting the activity level comprises:
periodically scanning the DSRC spectrum to detect the activity level on the DSRC spectrum.

4. The method of claim 3, further comprising:
transmitting a report comprising results of at least one scan of at least the portion of the DSRC spectrum.

5. The method of claim 3, further comprising:
receiving an instruction indicating whether use of at least the portion of the DSRC spectrum is allowed, the instruction being based at least in part on the activity level on at least the portion of the DSRC spectrum.

6. The method of claim 1, further comprising:
establishing a first communication channel, the first communication channel being outside of the DSRC spectrum; and
upon determining to use at least the portion of the DSRC spectrum, establishing a second communication channel for a transmission, at least a portion of the second communication channel being within the DSRC spectrum.

7. The method of claim 6, further comprising:
maintaining the first communication channel while the transmission occurs using the second communication channel.

8. The method of claim 6, further comprising:
determining that the transmission in the DSRC spectrum has terminated; and
terminating the use of the second communication channel.

9. The method of claim 1, wherein the detecting the activity level comprises:
detecting an energy level in the DSRC spectrum.

10. The method of claim 1, wherein the detecting the activity level comprises:
detecting a transmission of a packet in the DSRC spectrum; and
determining whether the packet is a DSRC packet.

11. The method of claim 10, wherein the determining whether the packet is a DSRC packet comprises:
analyzing a preamble of the packet; and
determining that the packet is a DSRC packet based at least in part on one or more characteristics of the analyzed preamble.

12. The method of claim 1, wherein the determining whether to use the DSRC spectrum comprises:
determining whether a level of interference caused by transmissions of the multi-mode device using the DSRC spectrum is below a threshold interference level.

13. The method of claim 12, further comprising:
determining whether the level of interference is below the threshold interference level for one or more different transmission power levels.

14. The method of claim 12, further comprising:
determining whether the level of interference is below the threshold interference level for one or more different antenna configurations of the multi-mode device.

15. The method of claim 12, wherein the threshold interference level is based at least in part on a geographical location of the multi-mode device.

16. A device for opportunistically using at least a portion of a dedicated short range communications (DSRC) spectrum, comprising:
a processor;
memory in electronic communication with the processor; and
instructions stored in the memory, the instructions being executable by the processor to:
operate a multi-mode device outside of the DSRC spectrum;
detect an activity level on at least the portion of the DSRC spectrum; and
determine whether to use at least the portion of the DSRC spectrum based at least in part on the detected activity level.

17. The device of claim 16, wherein the instructions are executable by the processor to:
receive, from an access point, a transmission comprising information indicating a capability of the access point to use the DSRC spectrum; and
send signaling information indicating a capability to use the DSRC spectrum.

18. The device of claim 16, wherein the instructions to detect the activity level are executable by the processor to:
periodically scan the DSRC spectrum to detect the activity level on at least the portion of the DSRC spectrum.

19. The device of claim 18, wherein the instructions are executable by the processor to:
transmit a report comprising results of at least one scan of at least the portion of the DSRC spectrum.

20. The device of claim 18, wherein the instructions are executable by the processor to:
receive an instruction indicating whether use of at least the portion of the DSRC spectrum is allowed, the instruction being based at least in part on the activity level on the DSRC spectrum.

21. The device of claim 16, wherein the instructions are executable by the processor to:
establish a first communication channel, the first communication channel being outside of the DSRC spectrum; and
upon determining to use at least the portion of the DSRC spectrum, establish a second communication channel for a transmission, at least a portion of the second communication channel being within the DSRC spectrum.

22. The device of claim 21, wherein the instructions are executable by the processor to:
maintain the first communication channel while the transmission occurs using the second communication channel.

23. The device of claim 21, wherein the instructions are executable by the processor to:
determine that the transmission in the DSRC spectrum has terminated; and
terminate the use of the second communication channel.

24. The device of claim 16, wherein the instructions to detect the activity level are executable by the processor to:
detect an energy level in the DSRC spectrum.

25. The device of claim 16, wherein the instructions to detect the activity level are executable by the processor to:
detect a transmission of a packet in the DSRC spectrum; and
determine whether the packet is a DSRC packet.

26. The device of claim 25, wherein the instructions to determine whether the packet is a DSRC packet are executable by the processor to:
analyze a preamble of the packet; and
determine that the packet is a DSRC packet based at least in part on one or more characteristics of the analyzed preamble.

27. The device of claim 16, wherein the instructions to determine whether to use the DSRC spectrum are executable by the processor to
determine whether a level of interference caused by transmissions of the multi-mode device using the DSRC spectrum is below a threshold interference level.

28. The device of claim 27, wherein the instructions are executable by the processor to:
determine whether the level of interference is below the threshold interference level for one or more different transmission power levels.

29. The device of claim 27, wherein the instructions are executable by the processor to:
determine whether the level of interference is below the threshold interference level for one or more different antenna configurations of the multi-mode device.

30. The device of claim 27, wherein the threshold interference level is based at least in part on a geographical location of the multi-mode device.

31. An apparatus for opportunistically using at least a portion of a dedicated short range communications (DSRC) spectrum, comprising:
means for operating a multi-mode device outside of the DSRC spectrum;
means for detecting an activity level on at least the portion of the DSRC spectrum; and
means for determining whether to use at least the portion of the DSRC spectrum based at least in part on the detected activity level.

32. The apparatus of claim 31, further comprising:
means for receiving, from an access point, a transmission comprising information indicating a capability of the access point to use the DSRC spectrum; and
means for sending signaling information indicating a capability to use the DSRC spectrum.

33. The apparatus of claim 31, wherein the means for detecting the activity level comprises:
means for periodically scanning the DSRC spectrum to detect the activity level on at least the portion of the DSRC spectrum.

34. The apparatus of claim 31, further comprising:
means for establishing a first communication channel, the first communication channel being outside of the DSRC spectrum; and
means for, upon determining to use at least the portion of the DSRC spectrum, establishing a second communication channel for a transmission, at least a portion of the second communication channel being within the DSRC spectrum.

35. The apparatus of claim 34, further comprising:
means for maintaining the first communication channel while the transmission occurs using the second communication channel.

36. The apparatus of claim 31, wherein the means for detecting the activity level comprises:
means for detecting an energy level in the DSRC spectrum.

37. The apparatus of claim 31, wherein the means for detecting the activity level comprises:
means for detecting a transmission of a packet in the DSRC spectrum; and
means for determining whether the packet is a DSRC packet.

38. The apparatus of claim 31, wherein the means for determining whether to use the DSRC spectrum comprises:
means for determining whether a level of interference caused by transmissions of the multi-mode device using the DSRC spectrum is below a threshold interference level.

39. A computer program product for opportunistically using at least a portion of a dedicated short range communications (DSRC) spectrum, the computer program product comprising a non-transitory computer-readable medium storing instructions executable by a processor to operate a multi-mode device outside of the DSRC spectrum;
detect an activity level on at least the portion of the DSRC spectrum; and
determine whether to use at least the portion of the DSRC spectrum based at least in part on the detected activity level.

40. The computer program product of claim 39, wherein the instructions are executable by the processor to:
establish a first communication channel, the first communication channel being outside of the DSRC spectrum; and
upon determining to use at least the portion of the DSRC spectrum, establish a second communication channel for a transmission, at least a portion of the second communication channel being within the DSRC spectrum.

41. The computer program product of claim 40, wherein the instructions are executable by the processor to:
maintain the first communication channel while the transmission occurs using the second communication channel.

42. The computer program product of claim 39, wherein the instructions to detect the activity level are executable by the processor to:
detect an energy level in the DSRC spectrum.

43. The computer program product of claim 39, wherein the instructions to determine whether to use the DSRC spectrum are executable by the processor to:
determine whether a level of interference caused by transmissions of the multi-mode device using the DSRC spectrum is below a threshold interference level.
